(19) United States
(12) Patent Application Publication
(10) Pub. No.: US 2025/0358846 A1
(43) Pub. Date: Nov. 20, 2025

(54) Techniques for Coexistence Operation with Multi-Link Devices

(71) Applicant: Cypress Semiconductor Corporation, San Jose, CA (US)

(72) Inventor: Sudhirkumar Prajapati, Milpitas, CA (US)

(73) Assignee: Cypress Semiconductor Corporation, San Jose, CA (US)

(21) Appl. No.: 18/667,238

(22) Filed: May 17, 2024

(51) Int. Cl. H04W 74/0816; H04W 74/08; H04W 84/04; H04W 84/12

(52) U.S. Cl. CPC H04W 74/0816; H04W 74/0866; H04W 84/045; H04W 84/12

(57) ABSTRACT

An upcoming start to communication activity on a wireless personal area network (WPAN) link with a WPAN device is identified by a processing device. A switch is made from a first WLAN link to a second WLAN link for communication with a WLAN device in response to identification of the upcoming start to the communication activity. The first WLAN link and the WPAN link utilize overlapping frequency bands and the second WLAN link and the WPAN link utilize no-overlapping frequency bands. An end to the communication activity on the WPAN link with the WPAN device may be identified. A switch is made from the second WLAN link to the first WLAN link for communication with the WLAN device in response to identification of the end to the communication activity.

### TECHNICAL FIELD

The present disclosure relates generally to the field of wireless communications, and more particularly, to techniques for coexistence operation with multi-link devices.

### BACKGROUND

Wireless devices use a variety of different wireless technologies to access wireless networks. This creates situations where multiple wireless technologies coexist in the same frequency band. For example, there may be a coexistence of a wireless local-area network (WLAN) technology, such as Wi-Fi, and a wireless personal area network (WPAN) technology, such as Bluetooth™ (BT). The coexistence of multiple wireless technologies in the same frequency band increases the radio frequency (RF) interference within the frequency band, making it more difficult for wireless devices to communicate.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary operating environment for coexistence operation with a multi-link device (MLD) according to some embodiments.

FIG. 2 illustrates an exemplary multi-link device (MLD) timing diagram according to some embodiments.

FIG. 3A illustrates various aspects of communicating upcoming communication activity according to some embodiments.

FIG. 3B illustrates various aspects of concurrent communication according to some embodiments.

FIG. 3C illustrates various aspects of communicating an end to communication activity on a link according to some embodiments.

FIG. 3D illustrates various aspects of communication after the end to communication activity on the link according to some embodiments.

FIG. 4 illustrates an exemplary logic flow for coexistence operation with multi-link devices according to some embodiments.

### DETAILED DESCRIPTION

The following description sets forth numerous specific details such as examples of specific systems, components, methods, and so forth, in order to provide a good understanding of various embodiments of the techniques described herein for coexistence operation with multi-link devices (MLDs). It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Different wireless communication devices may utilize the same frequency band for communication. For example, a WLAN communication device and a WPAN communication device may utilize the 2.4 gigahertz (GHz) frequency band for communication. Thus, when WLAN and WPAN communication devices operate simultaneously, RF interference can have a detrimental effect on their wireless communications. For example, BT devices and Wi-Fi devices can interfere with each other causing poor performance of both. The interference can be especially difficult to overcome when the WLAN and WPAN device are collocated (e.g., part of the same device). Wireless coexistence techniques are aimed at facilitating the ability of multiple wireless communication devices to communicate without causing harmful interference to each other.

Because of the numerous types and operational parameters of wireless communication devices as well as the complex and unpredictable interactions between various wireless communication devices, it can be challenging to reliably enable different wireless communication devices to utilize the same frequency band without experiencing significant interference. Adding further complexity, different wireless communication devices may communicate based on different technical standards. For example, WPAN communication devices may utilize the IEEE 802.15.4 or 802.15.1 technical standard and WLAN communication devices may utilize the IEEE 802.11 technical standard.

These challenges and complexities result in existing solutions failing to reliably enable different wireless communication devices to co-exist without detrimental effects on their performance. For example, some existing techniques utilize time-division multiplexing (TDM). However, due to the time division nature (i.e., taking turns using the medium), such existing techniques cause performance degradation and larger latencies. Further, signaling and processing is typically required to arrange and implement the TDM, which results in additional performance degradation and resource demands. These limitations can drastically reduce the usability of different wireless communication devices utilizing the same frequency band, contributing to excessive interference and inefficient systems, devices, and techniques with limited capabilities.

Embodiments of the present disclosure address the above and other problems by enabling WLAN devices to dynamically switch to a different link that uses a different frequency band based on upcoming WPAN device activity. Accordingly, WLAN and WPAN devices may be caused to operate in different frequency bands to enable concurrent wireless communications without performance degradation due to interference. In an illustrative embodiment, a processing device of an MLD may identify an upcoming start to communication activity on a WPAN link with a WPAN device (e.g., BT device). The MLD may switch from a first WLAN link to a second WLAN link for communication with a WLAN device (e.g., MLD AP) in response to identification of the upcoming start to the communication activity. The first WLAN link and the WPAN link may utilize overlapping frequency bands (e.g., 2.4 GHz frequency bands) and the second WLAN link and the WPAN link may utilize non-overlapping frequency bands (e.g., 2.4 GHz and 5 GHz frequency bands). The processing device of the MLD may identify an end to the communication activity on the WPAN link with the WPAN device and, in response, switch from the second WLAN link to the first WLAN link for communication with the WLAN device.

In these and other ways, components/techniques described hereby may provide many technical advantages. For example, embodiments may reduce RF interference and latency by moving WLAN traffic from a frequency band that overlaps with a WPAN link to a frequency band that does not overlap with the WPAN link. In another example, a secondary WLAN link (e.g., the non-overlapping WLAN link) may only be utilized during WPAN communication activity to maximize use of a primary WLAN link (e.g., the overlapping WLAN link), which may provide additional advantages, such as maximizing WLAN coverage (e.g., 2.4 GHz band provides more coverage than 5 GHz band). Thus, the computer-based techniques of the current disclosure improve wireless communications as compared to conventional approaches. Further, embodiments disclosed hereby can be practically utilized to improve the functioning of a computer and/or to improve a variety of technical fields including wireless communication, RF interference, and wireless coexistence techniques.

It will be appreciated that various aspects of telecommunication networks, capabilities, protocols, formats, and procedures relevant to the techniques described and terms referenced herein may be found in one or more IEEE standards, such as the 802.11 and 802.15.4 technical standards. For example, WPAN devices referenced herein may operate based, at least in part, on the 802.15.4 technical standard and WLAN devices referenced herein may operate based, at least in part, on the 802.11 technical standard (e.g., 802.11be).

The illustrative examples and embodiments provided above are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

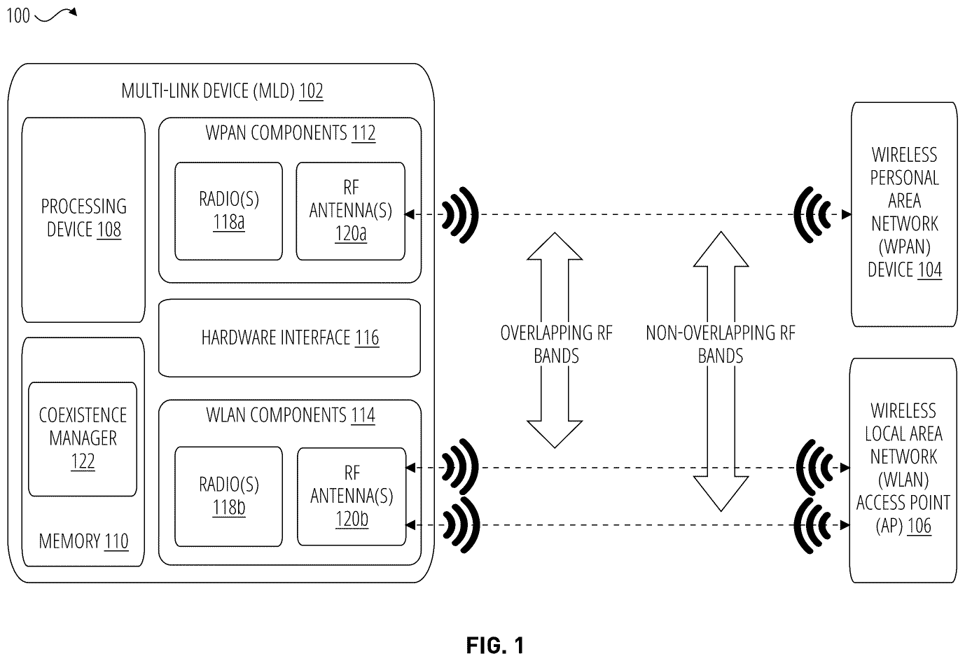

FIG. 1 illustrates an operating environment 100 for coexistence operation with a multi-link device (MLD) 102 according to some embodiments. The illustrated embodiment includes MLD 102, WPAN device 104, and WLAN access point (AP) 106. In some embodiments, communication between the MLD 102 and WPAN device 104 may interfere with communications between MLD 102 and WLAN AP 106 or vice a versa due to using an overlapping frequency band (e.g., 2.4 Ghz band). Accordingly, various embodiments described hereby may cause MLD 102 and WLAN AP 106 to switch and use a non-overlapping frequency band (e.g., 5 GHz or 6 GHz band) to prevent interference. In various such embodiments, the switch may occur in response to identifying an upcoming start to communication activity between MLD 102 and WPAN device 104. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, coexistence manager 122, or portions thereof, may be implemented by WPAN components 112 and/or WLAN components 114 without departing from the scope of this disclosure. Embodiments are not limited in this context.

The MLD 102 includes a processing device 108, a memory 110, one or more WPAN components 112, a hardware interface 116, and one or more WLAN components 114. The MLD 102 may support both WLAN and WPAN communications, such as Wi-Fi and BT, respectively. In various embodiments, the MLD 102 may include a single-radio MLD, also referred to as a multi-link single radio (MLSR) device. The memory 110 is coupled to the processing device 108 for storing instructions (including temporary data) that are executed by the processing device 108. In the illustrated embodiment, the memory 110 includes instructions for a coexistence manager 122. As will be discussed in more detail below, the coexistence manager 122 may operate to implement functionality described herein, such as identifying an upcoming start to communication activity between MLD 102 and WPAN device 104 and, in response, causing MLD 102 and WLAN AP 106 to switch and use a non-overlapping frequency band (e.g., 5 GHz or 6 GHz band). The MLD 102 may include any computing device that is able to communicate via a WPAN and communicate via a WLAN using more than one frequency band. For example, MLD 102 may include a mobile phone, a laptop, a desktop, or similar. The WPAN device 104 may include any computing device that is able to communicate via a WPAN. For example, the WPAN device 104 may include an internet of things (IoT) device, a smart watch, a wireless headset, or similar.

The WPAN components 112 include one or more radios 118a and one or more RF antennas 120a. For example, the WPAN components 112 may include a BT radio that is configured to communicate (e.g., transmit and/or receive) in a frequency band (e.g., the 2.4 GHz frequency band) and an RF antennas that is tuned to the frequency band (e.g., the 2.4 GHz frequency band). Similarly, the WLAN components 114 may include one or more radios 118a and one or more RF antennas 120b. For example, the WLAN components 114 may include a first Wi-Fi radio that is configured to communicate (e.g., transmit and/or receive) in a first frequency band (e.g., the 2.4 GHz frequency band), a second radio that is configured to communicate in a second frequency band (e.g., the 5 GHz frequency band), and a third radio that is configured to communicate in a third frequency band (e.g., the 6 GHz frequency band). Additionally, WLAN components 114 may include a first RF antenna that is tuned to the first frequency band (e.g., the 2.4 GHz frequency band), a second RF antenna that is tuned to the second frequency band (e.g., the 5 GHz frequency band), and a third RF antenna that is tuned to the third frequency band (e.g., the 5 GHz frequency band). In many embodiments, the 2.4 GHz frequency band may be the default or primary link used for communication between the MLD 102 and the WLAN AP 106.

As discussed herein, the MLD 102 may utilize a WPAN communication technology to communicate with WPAN device 104 and a WLAN communication technology to communicate with WLAN AP 106. For example, MLD 102 may include a mobile phone, WPAN device 104 may include a BT headset, and WLAN AP 106 may include a Wi-Fi access point. A Wi-Fi access point may include a WLAN AP that operates according to the Wi-Fi standard. Further, MLD 102 may include logic (e.g., coexistence manager 122) that identifies an upcoming start to communication activity between MLD 102 and WPAN device 104 and, in response, causes communication activity between MLD 102 and WLAN AP 106 to switch from a first link that utilizes an overlapping frequency band to a second link that utilizes a non-overlapping frequency band. Continuing with the previous example, if the mobile phone attempts to make a Voice over Internet Protocol (VOIP) while using the BT headset, interference can occur (or poor performance due to other coexistence techniques, such as TDM). This interference (or poor performance) may be due to the wireless connection between the mobile phone and the BT headset and the wireless connection between the mobile phone and the Wi-Fi access point using an overlapping frequency band (e.g., 2.4 GHz frequency band). Advantageously, embodiments described hereby, may cause the VoIP call to switch from a 2.4 GHz link to a 5 GHz or 6 GHz link, such as in response to detecting activation of the BT headset, to avoid interference with the BT headset. In many embodiments, an indication of the upcoming start to communication activity between MLD 102 and WPAN device 104 may be communicated from the WPAN components 112 to the WLAN components 114 via hardware interface 116, which may include an internal bus or similar.

Additionally, MLD 102 may include logic (e.g., coexistence manager 122) that identifies an end to communication activity between MLD 102 and WPAN device 104 and, in response, causes communication activity between MLD 102 and WLAN AP 106 to switch from the second link back to the first link. Continuing again with the previous example, if the BT headset is turned off, communication between the mobile phone and the Wi-Fi access point may be switched back to the first link. For example, turning off the BT headset may indicate that communication on the first link by the BT headset is concluding. Based on this, the communication activity between MLD 102 and WLAN AP 106 may be switched back to the preferred link (i.e., the first link). In some embodiments, the preferred link may be indicated by a user or administrator. Alternatively, the preferred link may be determined based on performance parameters, such as throughput, bandwidth, signal strength, and the like. In various embodiments, an indication of the end to communication activity between MLD 102 and WPAN device 104 may be communicated from the WPAN components 112 to the WLAN components 114 via hardware interface 116. In some embodiments, the WPAN components 112 may include or be referred to as a communication module. In various embodiments, the WLAN components 114 may include or be referred to as a multi-link module or a multi-link single radio (MLSR) module.

It should be noted that various components may be described and illustrated as separate for simplicity or clarity of description, however, one or more of these components may be combined or shared without departing from the scope of this disclosure. For example, a single radio may be configured to support communication on the 2.4 GHz, 5 GHZ, and 6 GHz frequency bands without departing from the scope of this disclosure. Similarly, it should be noted that although a single processing device is depicted in MLD 102 for simplicity, other embodiments may include multiple processing devices, storage devices, or devices. For example, WPAN components 112 and WLAN components 114 may include separate processing devices that implement various portions of coexistence manager 122. The processing device 108 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing devices 108 may also include one or more special-purpose processing devices such as an application specific integrated circuit (ASIC), a field programmable gate array (FPGA), a digital signal processor (DSP), network processor, or the like.

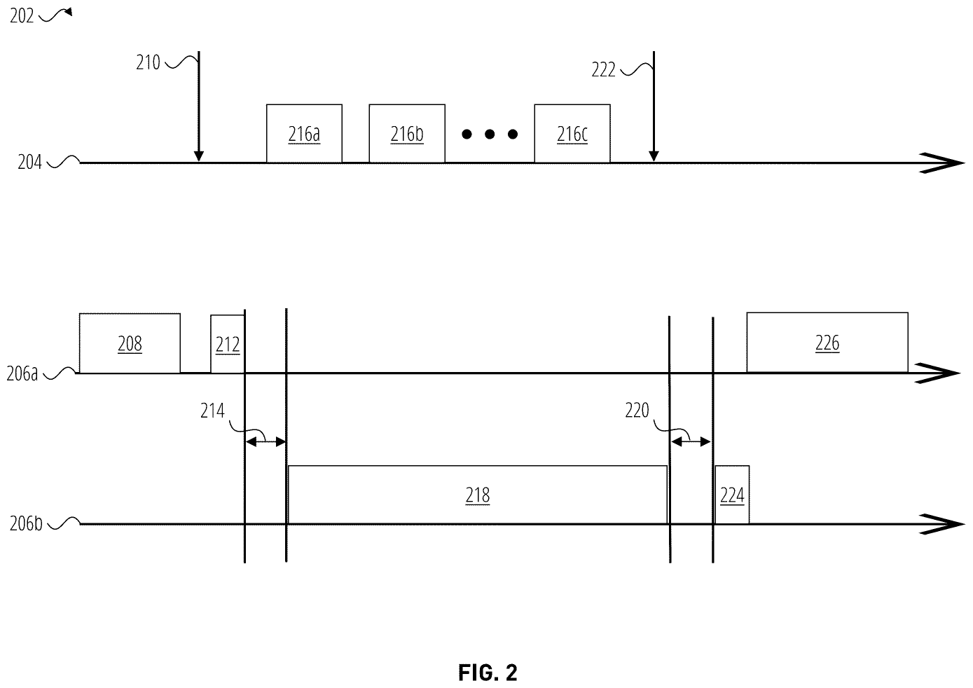

FIG. 2 illustrates an exemplary MLD timing diagram 202 according to some embodiments. In the illustrated embodiment, MLD timing diagram 202 includes activity on a WPAN link 204, a first WLAN link 206a, and a second WLAN link 206b. The MLD timing diagram 202 may correspond to signals exchanged between an MLD device and a WPAN device on the WPAN link 204 and signals exchanged between the MLD device and a WLAN device on the first and second WLAN links 206a, 206b as part of the techniques for coexistence operation with MLDs described hereby. Further, WPAN link 204 includes triggers 210, 222 that correspond to identification of an upcoming start to communication activity and an end to communication activity on WPAN link 204. However, as discussed in more detail below, these triggers 210, 222 indicate when the identification occurs and do not correspond to signals communicated via the WPAN link 204. One or more components of FIG. 2 may be the same or similar to one or more other components disclosed hereby. For example, the WPAN link 204 may be the same or similar to the link between MLD 102 and WPAN device 104, WLAN link 206a may be the same or similar to the link between MLD 102 and WLAN AP 106 with the overlapping RF band, WLAN link 206b may be the same or similar to the link between MLD 102 and WLAN AP 106 with the non-overlapping RF band. Further, aspects discussed with respect to various components in FIG. 2 may be implemented by one or more other components from one or more other embodiments without departing from the scope of this disclosure. Embodiments are not limited in this context.

In MLD timing diagram 202, initially communication of traffic 208 may be occurring on WLAN link 206a. Next, trigger 210 may occur in response to identification of an upcoming start to communication activity on the WPAN link 204. For example, WPAN components 112 may identify an upcoming start to communication activity on WPAN link 204 and provide an indication to the WLAN components 114 via hardware interface 116. In some embodiments, this indication may cause the WLAN components 114 to switch from WLAN link 206a to WLAN link 206b. In various embodiments, the MLD may begin communication on WPAN link 204 after the trigger 210. In various such embodiments, the MLD may wait a predetermined amount of time after the trigger 210 to begin communication on WPAN link 204. The communication on WPAN link 204 may include periodic or aperiodic traffic. In the illustrated embodiment, the communication on WPAN link 204 includes periodic traffic 216a, 216b, 216c (collectively referred to as traffic 216).

In response to the trigger 210 and/or as part of switching from WLAN link 206a to WLAN link 206b, a notification 212 may be transmitted on the WLAN link 206a to inform the WLAN device at the other end of the WLAN link 206a (e.g., WLAN AP 106). In some embodiments, the notification 212, or an acknowledgement received in response to the notification 212, may cause the MLD to transition from WLAN link 206a to WLAN link 206b. In many embodiments, the notification 212 may cause the WLAN device at the other end of the WLAN link 206a to not use the WLAN link 206a, such as for a set period of time or until another notification is received. In various embodiments, the notification 212 may include a frame or network packet transmitted on the WLAN link 206a. For example, the notification 212 may include a clear to send (CTS) to self frame or a frame with a power management bit.

Traditionally, the CTS-to-self frame may indicate that transmissions will be occurring on the link upon which it is transmitted (e.g., WLAN link 206a) in order to prevent other devices from utilizing the link. However, in various embodiments described hereby, the CTS-to-self frame may be utilized as the notification 212 to reserve the corresponding frequency band, which overlaps with the WPAN device. In this manner, the CTS-to-self frame can be repurposed to reserve the corresponding frequency for use by the WPAN device. In some embodiments, the CTS-to-self frame may include an indication of the duration of the activity. In some such embodiments, the WLAN device at the other end of the WLAN link 206a may resume use of the link after the duration is over. In one embodiment, the end of the communication activity of the WPAN link with the WPAN device may correspond to the end of the duration indicated in the CTS-to-self frame. In various embodiments, the CTS-to-self frame may be broadcast to multiple WLAN device to prevent the WLAN devices from utilizing the frequency band during WPAN activity.

In various embodiments, the notification 212 may include a frame with a power management bit set to indicate that the MLD will transition the WLAN link 206a into a power save mode after conclusion of the current frame exchange. This indication may be used to prevent the WLAN device at the other end of WLAN link 206a from utilizing WLAN link 206a when the WPAN link 204 is being used. In this manner, the power management bit can be repurposed to reserve the corresponding frequency for use by the WPAN device.

In many embodiments, the power save mode may place the corresponding radio in a doze or sleep power state. In the power save mode, the corresponding radio may be turned off. In some embodiments, the frame may include a null frame with the power management bit set to one. In some such embodiments, the null frame may include a media access control (MAC) header followed by a frame check sequence (FCS) trailer. In various embodiments, the power management bit may be included in a frame control field set of the frame. In one or more embodiments, a similar frame (e.g., except with the power management bit set to zero) may be sent on the WLAN link 206b to indicate the WLAN link 206b will be transitioning to an awake state. As discussed in more detail below, at the conclusion of traffic on the WPAN link 204, another frame may be sent on the WLAN link 206b with the power management bit set to indicate that the MLD will transition the WLAN link 206b to the power save mode and/or another frame may be sent on the WLAN link 206a with the power management bit set to indicate that the MLD will transition the WLAN link 206a back to an active mode. In some embodiments, the MLD may determine whether to use a CTS-to-self frame of a frame with a power management bit set. For example, if the traffic on WPAN link 204 is for an unknown duration, the frame with a power management bit set may be utilized or if the traffic on WPAN link 204 is for a known duration, the CTS-to-self frame may be utilized.

Additionally, in response to the notification 212, the MLD may transition traffic from WLAN link 206a to WLAN link 206b. This transition may take an amount of time corresponding to a switch delay 214. Once, the switch has occurred, the MLD may utilize WLAN link 206b to communicate traffic 218. As shown in the illustrated embodiment, traffic 216 on WPAN link 204 may occur concurrently with traffic 218 on WLAN link 206b, which improves performance and reduces latency when compared to other techniques, such as TDM, that utilize WLAN link 206a for traffic 218.

Next, trigger 222 may occur in response to identification of an end to communication activity on WPAN link 204. For example, WPAN components 112 may identify an end to communication activity on WPAN link 204 and provide an indication to the WLAN components 114 via hardware interface 116. This indication may trigger the WLAN components 114 to switch from WLAN link 206b to WLAN link 206a. In response to the trigger 210 and/or as part of switching from WLAN link 206b to WLAN link 206a, a notification 224 may be transmitted on the WLAN link 206b to inform the WLAN device at the other end of the WLAN link 206b (e.g., WLAN AP 106). In some embodiments, the notification 212, or an acknowledgement received in response to the notification 212, may cause the MLD to transition from WLAN link 206b to WLAN link 206a. The notification 224 may be the same or similar to notification 212 and may include a frame or network packet transmitted on the WLAN link 206a. For example, the notification 224 may include a null frame with a power management bit set to one. The transition from WLAN link 206b to WLAN link 206a may take an amount of time corresponding to a switch delay 220. Once, the switch has occurred, the MLD may utilize WLAN link 206a to communicate traffic 226.

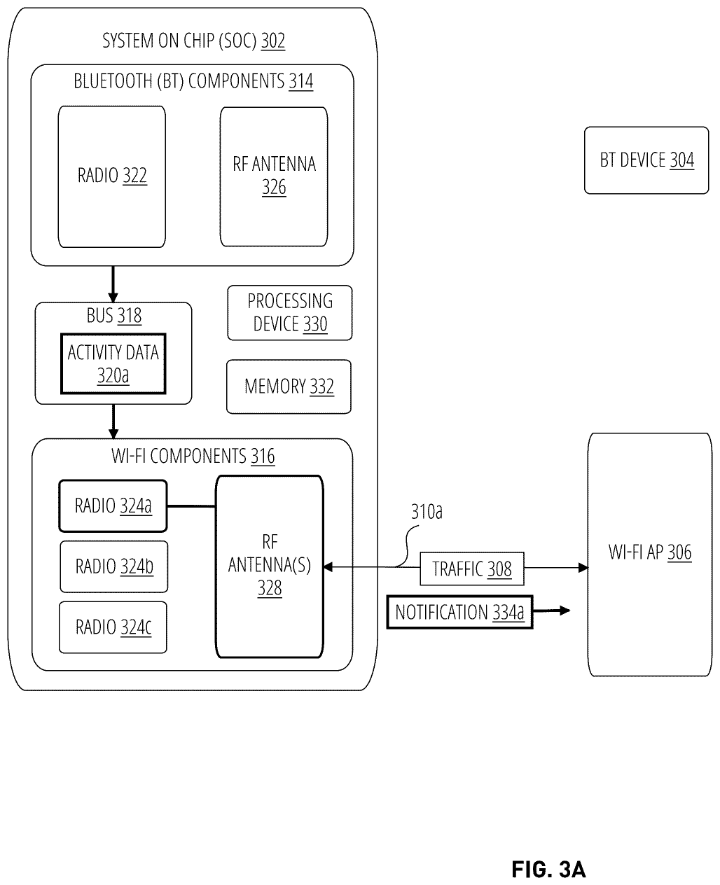

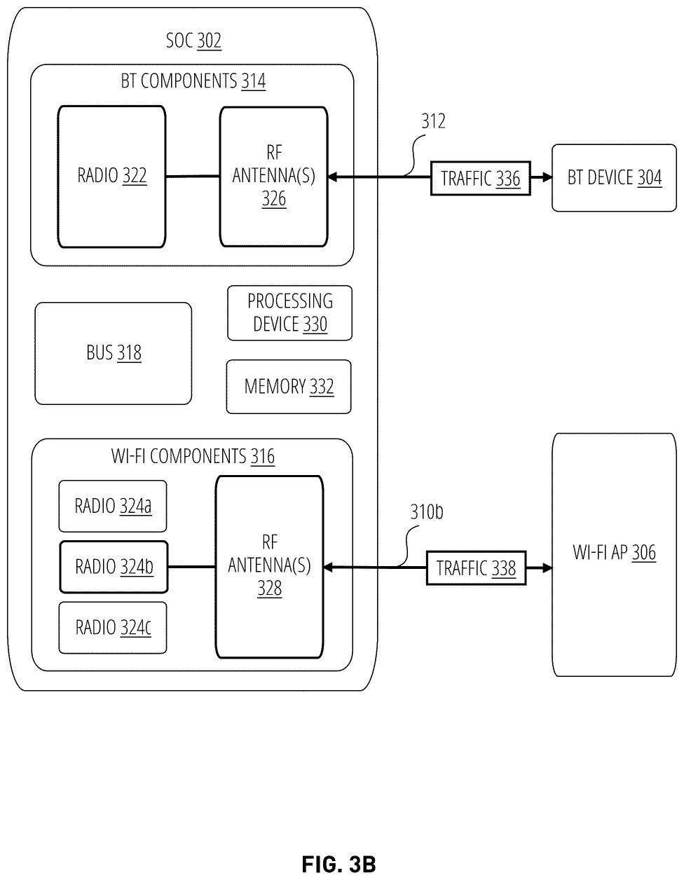

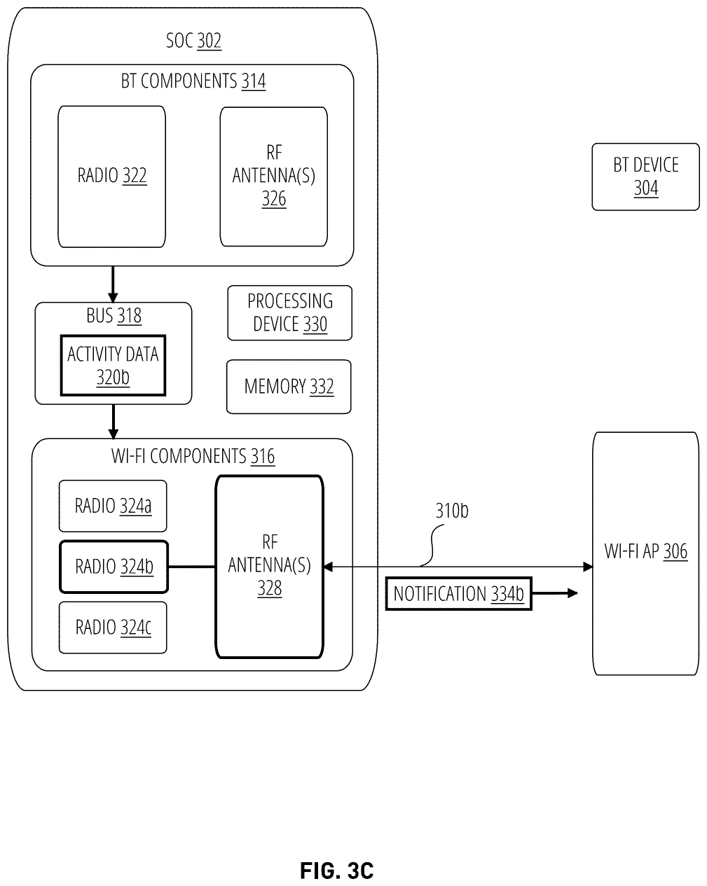

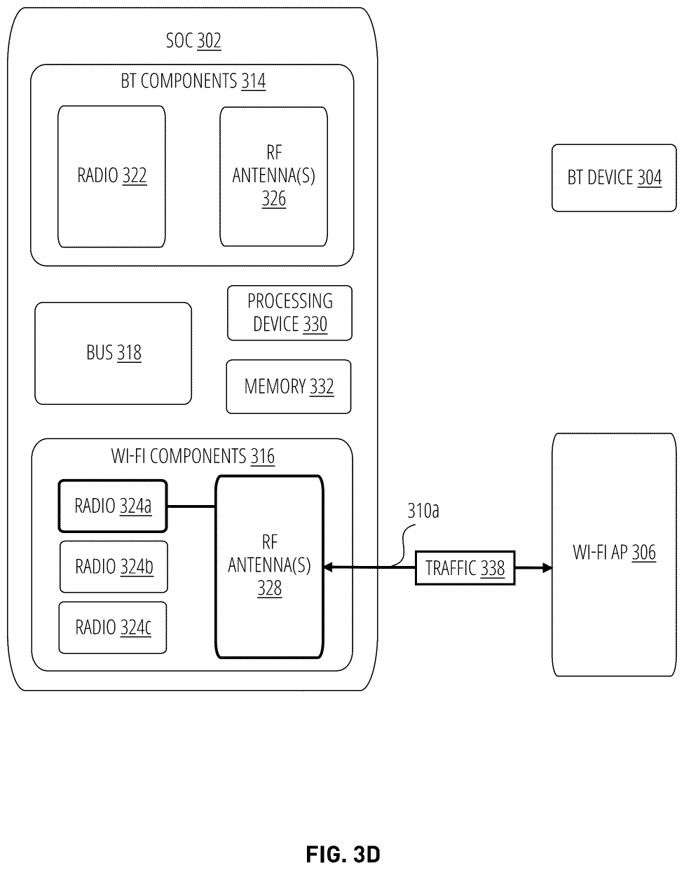

FIGS. 3A-3D illustrate various aspects of switching links based on BT activity according to some embodiments. The illustrated embodiment includes a system on chip (SOC) 302, a BT device 304, traffic 308 on Wi-Fi link 310a that communicatively couples SOC 302 to Wi-Fi AP 306. The SOC 302 includes BT components 314, Wi-Fi components 316, bus 318 communicatively coupling BT components 314 to Wi-Fi components 316, a processing device 330, and memory 332. The BT components 314 include a radio 322 and an RF antenna 326. In some embodiments, the BT components 314 may include or be referred to as a communication module. The Wi-Fi components 316 include radios 324a, 324b, 324c (collectively referred to as radios 324) and one or more RF antennas 328. In some embodiments, the Wi-Fi components 316 may include or be referred to as a multi-link module or a multi-link single radio (MLSR) module. One or more components of FIGS. 3A-3D may be the same or similar to one or more other components disclosed hereby. For example, the SOC 302 may be the same or similar to MLD 102. In another example, bus 318 may be the same or similar to hardware interface 116. In yet another example, BT components 314 and/or Wi-Fi components 316 may be the same or similar to WPAN components 112 and/or WLAN components 114, respectively. Further, aspects discussed with respect to various components in FIGS. 3A-3D may be implemented by one or more other components from one or more other embodiments without departing from the scope of this disclosure. For example, one or more of radios 324, 322 and/or RF antennas 328, 326 may be combined into a single radio and/or antenna that supports multiple frequency bands or wireless communication technologies (e.g., WLAN and WPAN) without departing from the scope of this disclosure. Embodiments are not limited in this context.

Referring to FIG. 3A, aspects of communicating upcoming communication activity on BT link 312 between BT components 314 and Wi-Fi components 316 as well as informing Wi-Fi AP 306 to not communicate with SOC 302 via Wi-Fi link 310a are shown. More specifically, initially, Wi-Fi link 310a is being used to communicate traffic 308 between a Wi-Fi AP 306 and SOC 302 via radio 324a and a corresponding one of RF antennas 328. The Wi-Fi link 310a may utilize a 2.4 GHz frequency band. The BT components 314 may then identify an upcoming start to communication activity between SOC 302 and BT device 304 over a link that also utilizes the 2.4 GHz frequency band. For example, BT components 314 may detect a profile becoming active or may identify data pending transmission (e.g., data in a buffer). In response to identifying the upcoming start to communication activity between SOC 302 and BT device 304, BT components 314 may cause activity data 320a to be communicated to Wi-Fi components 316 via bus 318. This activity data 320a may inform Wi-Fi components 316 of the upcoming start to communication activity and initiate a procedure to switch from Wi-Fi link 310a to another Wi-Fi link that does not interfere with communications between SOC 302 and BT device 304. The link switching procedure may include transmission of a notification 334a to the Wi-Fi AP 306. The notification 334a may prevent Wi-Fi AP 306 from utilizing Wi-Fi link 310a to communicate with SOC 302. The notification 334a may be the same or similar to notification 212, and, as previously described, may include a CTS-to-self frame or a frame with a power management bit set. It will be appreciated that Wi-Fi link 310a does not have to be in active use (e.g., communicating traffic 308) to utilize the link switching described hereby.

Referring to FIG. 3B, concurrent communication between SOC 302 and BT device 304 and SOC 302 and Wi-Fi AP 306 is shown. More specifically, after the switch from Wi-Fi link 310a to Wi-Fi link 310b, BT link 312 may be used to communicate traffic 336 between the SOC 302 and BT device 304 at the same time as Wi-Fi link 310b is used to communicate traffic 308 between the SOC 302 and Wi-Fi AP 306. Thus, switching from Wi-Fi link 310a to Wi-Fi link 310b moves the traffic 308 from Wi-Fi link 310a to Wi-Fi link 310b. As previously mentioned, Wi-Fi link 310a and BT link 312 may utilize overlapping frequency bands (e.g., 2.4 GHz frequency bands) and Wi-Fi link 310b and BT link 312 may utilize non-overlapping frequency bands (e.g., 5 GHz or 6 GHz frequency band and 2.4 GHz frequency band, respectively). The radio 322 and RF antenna 326 in BT components 314 may be utilized to communicate with BT device 304 via BT link 312 and the radio 324b and a corresponding one of RF antennas 328 in Wi-Fi components 316 may be utilized to communicate with Wi-Fi AP 306 via Wi-Fi link 310b.

Referring to FIG. 3C, aspects of communicating an end to communication activity on BT link 312 between BT components 314 and Wi-Fi components 316 as well as informing Wi-Fi AP 306 to not communicate with SOC 302 via Wi-Fi link 310b are shown. More specifically, the BT components 314 may identify an end to communication activity between SOC 302 and BT device 304 over BT link 312. For example, BT components 314 may detect a profile becoming inactive or may fail to identify data pending transmission (e.g., an empty buffer). In response to identifying the end communication activity between SOC 302 and BT device 304, BT components 314 may cause activity data 320b to be communicated to Wi-Fi components 316 via bus 318. This activity data 320b may inform Wi-Fi components 316 of the end to communication activity and initiate a procedure to switch from Wi-Fi link 310b to Wi-Fi link 310a. The procedure may include transmission of a notification 334b to the Wi-Fi AP 306 on Wi-Fi link 310b. The notification 334a may prevent Wi-Fi AP 306 from utilizing Wi-Fi link 310b to communicate with SOC 302. The notification 334b may be the same or similar to notification 224, and, as previously described, may include a CTS-to-self frame or a frame with a power management bit set.

Referring to FIG. 3D, once the switch back to Wi-Fi link 310a is complete, the Wi-Fi link 310a may be used to communicate traffic 336 between the SOC 302 and Wi-Fi AP 306. Thus, radio 324a and a corresponding one of RF antennas 328 may be utilized to communicate with Wi-Fi AP 306 via Wi-Fi link 310a. In various embodiments, switching back to Wi-Fi link 310a at the end of the communication activity between SOC 302 and BT device 304 may provide increased coverage as opposed to remaining on Wi-Fi link 310b.

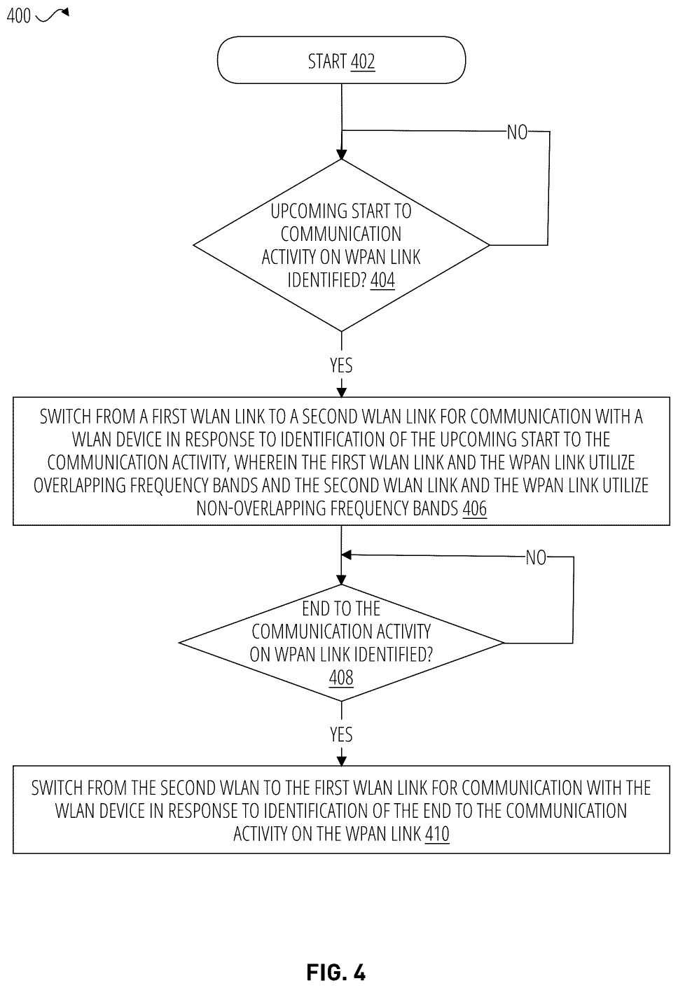

FIG. 4 illustrates a logic flow 400 for coexistence operation with multi-link devices according to some embodiments. The logic flow 400 may be performed by processing logic that may include hardware and/or control logic (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of logic flow 400 may be performed by one or more components of MLD 102 or SOC 302. Embodiments are not limited in this context.

With reference to FIG. 4, logic flow 400 illustrates example functions used by various embodiments. Although specific function blocks (“blocks”) are disclosed in logic flow 400, such blocks are examples. That is, embodiments are well suited to performing various other blocks or variations of the blocks recited in logic flow 400. It is appreciated that the blocks in logic flow 400 may be performed in an order different than presented, and that not all of the blocks in logic flow 400 may be performed.

Logic flow 400 begins at start block 402. From start block 402, the logic flow 400 proceeds to decision block 404 where it is determined if an upcoming start to communication activity on a WPAN link has been identified. For example, coexistence manager 122 or one or more of WPAN components 112 may identify an upcoming start to communication activity on a WPAN link based on a BT profile becoming active. If an upcoming start to communication activity on the WPAN link has not been identified, the logic flow 400 may return to decision block 404 and await identification of an upcoming start to communication activity on the WPAN link. If an upcoming start to communication activity of the WPAN link has been identified, the logic flow 400 may proceed to block 406.

At block 406 a switch from a first WLAN link to a second WLAN link for communication with a WLAN device may be made in response to identification of the upcoming start to the communication activity. The first WLAN link and the WPAN link may utilize overlapping frequency bands (e.g., 2.4 GHz frequency bands) and the second WLAN link and the WPAN link utilize no-overlapping frequency bands (e.g., a 2.4 GHz frequency band and a 5 or 6 GHz frequency band. For example, a switch may be made from a 2.4 GHz WLAN link to a 6 GHz WLAN link to prevent interference with a 2.4 GHz WPAN link. In some embodiments, an indication of the upcoming start to communication activity on the WPAN link may be communicated via hardware interface 116 (or bus 318) to cause the WLAN components 114 (or Wi-Fi components 316) to switch from the first WLAN link to the second WLAN link in response to identification of an upcoming start to communication activity on the WPAN link.

Proceeding to decision block 408, it may be determined if an end to the communication activity on a WPAN link has been identified. For example, coexistence manager 122 or one or more of WPAN components 112 may identify an end to the communication activity on the WPAN link based on a BT profile becoming inactive. If an end to communication activity on the WPAN link has not been identified, the logic flow 400 may return to decision block 408 and await identification of an end to communication activity on the WPAN link. If an end to communication activity of the WPAN link has been identified, the logic flow 400 may proceed to block 410.

At block 410 a switch from the second WLAN link to the first WLAN link for communication with the WLAN device may be made in response to identification of the end to the communication activity on the WPAN link. In some embodiments, the switch back to the first WLAN link may additionally occur in response to the first WLAN link being the preferred link for communication between the WLAN device and the WLAN AP. The preferred link may be indicated by a user or administrator. Additionally, or alternatively, the preferred link may be determined based on performance parameters, such as throughput, bandwidth, signal strength, and the like. In various embodiments, the preferred link may change based on performance parameters. In various such embodiments, if the preferred link has changed to the second WLAN link, the second WLAN link may continue to be used after identification of the end to the communication activity on the WPAN link. In other embodiments, the preferred link may have always been the second WLAN link and the WLAN device was temporarily using the first WLAN link initially do to other considerations, such as a manual override. In such other embodiments, the WLAN device may continue to use the second WLAN link after identification of the end to the communication activity on the WPAN link. In some embodiments, an indication of the end to communication activity on the WPAN link may be communicated via hardware interface 116 (or bus 318) to cause the WLAN components 114 (or Wi-Fi components 316) to switch from the second WLAN link to the first WLAN link in response to identification of an upcoming start to communication activity on the WPAN link.

In the above description, some portions of the detailed description are presented in terms of algorithms and symbolic representations of operations on analog signals and/or digital signals or data bits within a non-transitory storage medium. These algorithmic descriptions and representations are the means used by those skilled in the data processing arts to most effectively convey the substance of their work to others skilled in the art. An algorithm may, for example, be a self-consistent sequence of operations leading to a desired result. The operations are those demanding physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

Reference in the description to “an embodiment,” “one embodiment,” “an example embodiment,” “some embodiments,” “various embodiments”, and the like means that a particular feature, structure, step, operation, or characteristic described in connection with the embodiment(s) is included in at least one embodiment of the disclosure. Further, the appearances of the phrases “an embodiment,” “one embodiment,” “an example embodiment,” “some embodiments,” “various embodiments”, and the like in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “operating,” “identifying”, “determining,” “operating,” “sending,” “receiving,” “generating,” “switching,” or the like, refer to the actions and processes of a processing device, an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes at least one of A or B” or “X includes A or B” is intended to mean any of the natural inclusive permutations. That is, if X includes A; X includes B; or X includes both A and B, then “X includes at least one of A or B” or “X includes A or B” is satisfied under any of the foregoing instances. Similarly, “X includes one or more of A and B” should be interpreted the same as “X includes at least one of A or B”. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus (e.g., such as a wireless communication device including at least one of an end device, a client device, a station (STA), an access point, a router, or a co-ordinator) for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments. Further, a “computer-readable medium” or “computer-readable storage medium” may be non-transitory.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying, by a processing device, an upcoming start to communication activity on a wireless personal area network (WPAN) link with a WPAN device; and
switching from a first wireless local area network (WLAN) link to a second WLAN link to communicate with a WLAN device in response to identifying the upcoming start to the communication activity, wherein the first WLAN link and the WPAN link utilize overlapping frequency bands and the second WLAN link and the WPAN link utilize non-overlapping frequency bands.

2. The method of claim 1, further comprising:
identifying an end to the communication activity on the WPAN link with the WPAN device; and
switching from the second WLAN link to the first WLAN link to communicate with the WLAN device in response to identifying the end to the communication activity on the WPAN link.
The method of claim 2, wherein identifying the end to the communication activity on the WPAN link comprises communication between a WPAN component and a WLAN component via a hardware interface.

3. The method of claim 2, further comprising triggering transmission of a notification on the second WLAN link to the WLAN device in response to identification of the end to the communication activity on the WPAN link with the WPAN device, wherein the notification comprises a frame with a power management bit set to one.

4. The method of claim 1, further comprising triggering transmission of a notification on the first WLAN link to the WLAN device in response to identifying the upcoming start to communication activity on the WPAN link with the WPAN device.

5. The method of claim 4, wherein the notification comprises a frame with a power management bit set to one.

6. The method of claim 4, wherein the notification comprises a clear to send (CTS) to self frame.

7. The method of claim 1, wherein identifying the upcoming start to the communication activity on the WPAN link comprises detecting an active WPAN profile.

8. The method of claim 1, wherein identifying the upcoming start to the communication activity on the WPAN link comprises communication between a WPAN component and a WLAN component via a hardware interface.

9. The method of claim 1, wherein the overlapping frequency bands comprise at least a portion of a range of frequencies between 2.4 GHz and 2.5 GHz.

10. A multi-link device (MLD) comprising:
a plurality of radios; and
a processing device coupled to the plurality of radios, the processing device configured to:
identify an upcoming start to communication activity on a wireless personal area network (WPAN) link with a WPAN device; and
switch from a first wireless local area network (WLAN) link to a second WLAN link to communicate with a WLAN device in response to identifying the upcoming start to the communication activity, wherein the first WLAN link and the WPAN link utilize overlapping frequency bands and the second WLAN link and the WPAN link utilize non-overlapping frequency bands.

11. The MLD of claim 10, wherein the one or more processors are further configured to:
identify an end to the communication activity on the WPAN link with the WPAN device; and
switch from the second WLAN link to the first WLAN link to communicate with the WLAN device in response to identifying the end to the communication activity on the WPAN link.

12. The MLD of claim 11, wherein identifying the end to the communication activity on the WPAN link comprises communication between a WPAN component and a WLAN component via a hardware interface.

13. The MLD of claim 10, wherein the one or more processors are further configured to trigger transmission of a notification on the first WLAN link to the WLAN device in response to identifying the upcoming start to communication activity on the WPAN link with the WPAN device.

14. The MLD of claim 13, wherein the notification comprises a frame with a power management bit set to one.

15. The MLD of claim 13, wherein the notification comprises a clear to send (CTS) to self frame.

16. The MLD of claim 10, wherein identifying the upcoming start to the communication activity on the WPAN link comprises detecting an active WPAN profile.

17. The MLD of claim 10, wherein identifying the upcoming start to the communication activity on the WPAN link comprises communication between a WPAN component and a WLAN component via a hardware interface.

18. A system on chip (SOC) device, comprising:
a multi-link (ML) module comprising a plurality of radios, and a processing device coupled to the plurality of radios; and
a communication module comprising a different radio, the communication module communicatively coupled to the ML module via a hardware interface;
wherein the processing device is configured to:
identify an upcoming start to communication activity on a wireless personal area network (WPAN) link with a WPAN device, the upcoming start identified based on data received from the communication module via the hardware interface; and
switch from a first WLAN link to a second WLAN link to communicate with a WLAN device in response to identifying the upcoming start to the communication activity, wherein the first WLAN link and the WPAN link utilize overlapping frequency bands and the second WLAN link and the WPAN link utilize non-overlapping frequency bands.

19. The SOC device of claim 18, wherein the one or more processors are further configured to:
identify an end to the communication activity on the WPAN link with the WPAN device; and
switch from the second WLAN link to the first WLAN link to communicate with the WLAN device in response to identifying the end to the communication activity on the WPAN link.

20. The SOC device of claim 18, wherein the one or more processors are further configured to trigger transmission of a notification on the first WLAN link to the WLAN device in response to identification of the upcoming start to communication activity on the WPAN link with the WPAN device.
